(19) United States
(12) Patent Application Publication
(10) Pub. No.: US 2006/0046710 A1
(43) Pub. Date: Mar. 2, 2006

(54) Test system for checking transmission processes in a mobile radio network, and method for authenticating a mobile telephone using one such test system

(75) Inventors: Martin Lohlein, Wendelstein (DE); Hans Banken, Schwabach (DE); Reinhard Bergmann, Schwabach (DE)

Correspondence Address: BROWDY AND NEIMARK, P.L.L.C.;624 NINTH STREET, NW, SUITE 300, WASHINGTON, DC, 20001-5303, US

(73) Assignee: Sigos Systemintegration GmbH, Nurnberg (DE)

(21) Appl. No.: 10/536,356

(22) PCT Filed: Nov. 8, 2003
(86) PCT No.: PCT/EP03/12492

§ 371 Date: May 26, 2005

(30) Foreign Application Priority Data
Nov. 28, 2002 (DE) 10255428.5

(51) Int. Cl. H04Q 7/20

(52) U.S. Cl. 455/423; 455/558

(57) ABSTRACT

A test system (1) serves to check transmission processes in a mobile radio network (2). The latter comprises a central switching computer (8), a local mobile telephone (13) equipped for SIM communication, and a transmission unit (3) comprising a local transmission unit (5). Other components of the test system (1) include a local SIM simulation computer (10), which is connected to the local transmission unit (5) on one hand and to the mobile telephone (13) on the other hand, a control computer (23), which is used for controlling the testing operation, and which is connected to the mobile radio network (2), as well as an authentication computer (14), which is connected to the SIM simulation computer (10) and with which the mobile telephone (13) can be authenticated. For the authentication, a method is used that requires only two communication steps over the remote signal connection.

The invention relates to a test system for checking transmission processes in a mobile radio network. The invention additionally relates to a method for authenticating a mobile telephone using such a test system.

In the field of telecommunication, a high degree of quality and functionality of the mobile radio network can be guaranteed for the end user only if the components of the mobile radio network, i.e., switching computers, mobile telephones and transmission stations, as well as the communication between them are tested regularly. In addition to the tests of the hardware components of the mobile radio network, software tests and software updates need to be performed within the framework of such tests as well. Also, roaming tests, i.e., tests regarding the contractually agreed-upon use of third-party mobile radio networks nationally and abroad must be performed regularly. Roaming tests are standardized and must be performed whenever a network operator enters into new network cooperations or the status of existing network cooperations changes. Standardized tests are also performed in the case of error messages, as well as in the case of an expansion or change in the functional scope of the mobile network. Additionally, individual tests, which may be expansions of existing standards or entirely tailored to the requirements of a network operator, are performed so that a maximum functional reliability is ensured for the end user. At the same time, regular testing operations also increase the average availability of the mobile radio network. The above tests, if they are performed manually by taking a mobile telephone to a testing location and testing various Subscriber Identification Modules (SIM) that cooperate with the mobile telephone are extensive, however, and tie up a large number of staff. For this reason these tests, as a rule, take place in an automated manner. Components of associated test systems must be distributed usually over large areas for a test of local stations and they must be connected to one another via an appropriate network infrastructure (LAN/WAN) of the operator. For certain tests, which are known from the market, to be performed at the respective locations, testing interfaces, which are mobile telephones or which emulate them, must be equipped with an appropriate SIM card. Within the framework of these tests, regardless of whether it is a standardized test or an operator-specific test, a plurality of SIM cards must, as a rule, be tested at one location. The number of cards depends on the number of mobile radio networks to be tested and on the type of the respective test.

An additional test system is known from DE 198 31 929 C1, wherein a central control computer is provided, which receives SIM cards with which the mobile telephones within the test system cooperate and which controls the test connection of the SIM cards to the mobile telephones as a remote signal connection. With a test system of this type it is possible to test a plurality of SIM cards without having to exchange them at the location of the mobile telephone. In the test system of DE 198 31 929 C1, the data of the SIM cards are transmitted over the remote signal connection during the testing operation. Because of the large number of communication steps between the mobile telephone and the SIM card (e.g., during readout of the telephone directory on the SIM card) and the delay that is caused by the transmission over the remote signal connection (round-trip delay), the testing operation, especially for a plurality of SIM cards, takes a very long time. Additionally, transmitting the data over the remote signal connection presents a security risk. Also, the testing speed is limited by the data transmission bandwidth that is maximally attainable by the SIM cards and by the internal processor performance of the SIM cards. The authentication of a mobile telephone, i.e., identification of this mobile telephone by the network, is time-critical. It must take place according to a specified communication protocol, which is specified, for example, in the international standard ISO 7816 Part 3. The delay in the transmission over the remote signal connection may cause the authentication to fail.

It is therefore a first object of the present invention to improve a test system for checking transmission processes in a mobile radio network in such a way that tests with a plurality of SIM data sets belonging to different SIM cards can be performed with little effort.

This object has been met according to the invention with a test system having the characteristics specified in claim 1.

In accordance with the invention it was recognized that, in order to test transmission processes in a mobile radio network, it is not absolutely necessary to operate with “physical”, i.e., with real SIM cards. These physical SIM cards are replaced, at least as far as the SIM data are concerned that are locally associated with the mobile telephone, with a SIM simulation of a SIM simulation computer, i.e., with a “virtual” SIM card. This makes it possible to locally test card data for a plurality of different SIM cards without having to locally manually exchange the cards.

At the same time the transmission of sensitive SIM data over central components of the mobile radio network, as it is the case with a central administration of physical SIM cards, is avoided. Since the SIM simulation computer and also the authentication computer are not subject to the same limitations regarding their space and performance requirements as a SIM card, they can be designed very powerful regarding their computing and communication performance. At the same time, the physical SIM card, which is relatively limited regarding its computing and communication performance, can be largely or completely dispensed with. This results in a marked increase in the data throughput during the testing operation of a set of SIM data. The local placement of the SIM simulation computer, i.e., adjacent to the testing location of the mobile telephone, permits with relatively little effort a high transmission bandwidth between the simulation computer and mobile telephone.

The inventive test system may be used, for example, for mobile radio networks of the type GSM, GPRS or UMTS. The term “SIM card” is therefore used representative for both SIM cards and corresponding data cards of other types of mobile radio networks.

An embodiment of the test system according to claim 2 is of advantage especially if the authentication computer is implemented as a central component. In this manner the mobile radio network is used additionally for the data connection of the authentication computer. As a result, the data communication between the simulation computer and the authentication computer can also take place at a high transmission bandwidth.

A SIM simulation computer according to claim 3 increases the flexibility of the test system. A testing set of SIM data may be stored on the simulation computer, which is routinely processed within the framework of a testing operation with an associated mobile telephone. This may take place fully automatically.

With the aid of an embodiment of the SIM simulation computer according to claim 4, it is possible to influence the course of a test. Especially the structure and content of the information of the simulated virtual SIM card may be different from those on the physical SIM card. Specifically, the completion speed of the tests can be significantly increased with an appropriate selection of the simulated (virtual) SIM card. Additionally, future SIM card models, for which physical SIM cards do not yet exist, can be tested regarding their impact on the data communication in the mobile radio network. This increases the flexibility of the test system.

A SIM simulation computer according to claim 5 leads to an added optimization of the application flexibility of the test system. This permits the implementation of arrangements, for example, in which the SIM simulation computer always accesses the authentication computer and/or the mobile telephone in the test system that is not currently used to capacity.

The same applies for the implementation of an authentication computer according to claim 6.

With the aid of an authentication computer according to claim 7, the diversity of the mobile radio network tests that can be performed with the aid of the test system can be increased further. In addition to standard authentication algorithms, operator-specific algorithms may be implemented as well. An authentication computer according to claim 8 uses a physical SIM card to calculate an authentication response value. The authentication through the physical SIM card is required for the SIM simulation if the mobile radio network requests an authentication which cannot be calculated without the actual SIM card.

It is an additional object of the present invention to provide an authentication method for a mobile telephone that is faster within the framework of the test of a mobile radio network regarding its completion time.

This object is met according to the invention with a method comprising the steps specified in claim 9.

The number of communication steps over a remote signal connection is minimized by the inventive method. With this method, only two communication steps are required over the remote signal connection for the authentication, even though this requires four communication steps for the communication between mobile telephone and SIM card according to ISO 7817 Part 3.

An example implementation of the invention will be explained in more detail below based on the drawing, in which:

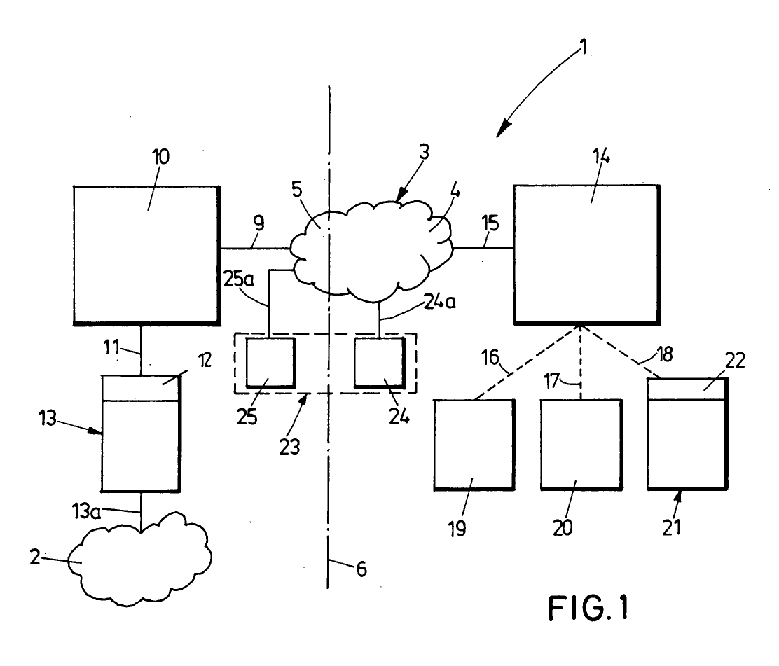

FIG. 1 shows an inventive test system for checking transmission processes in a mobile radio network in a schematic block illustration;

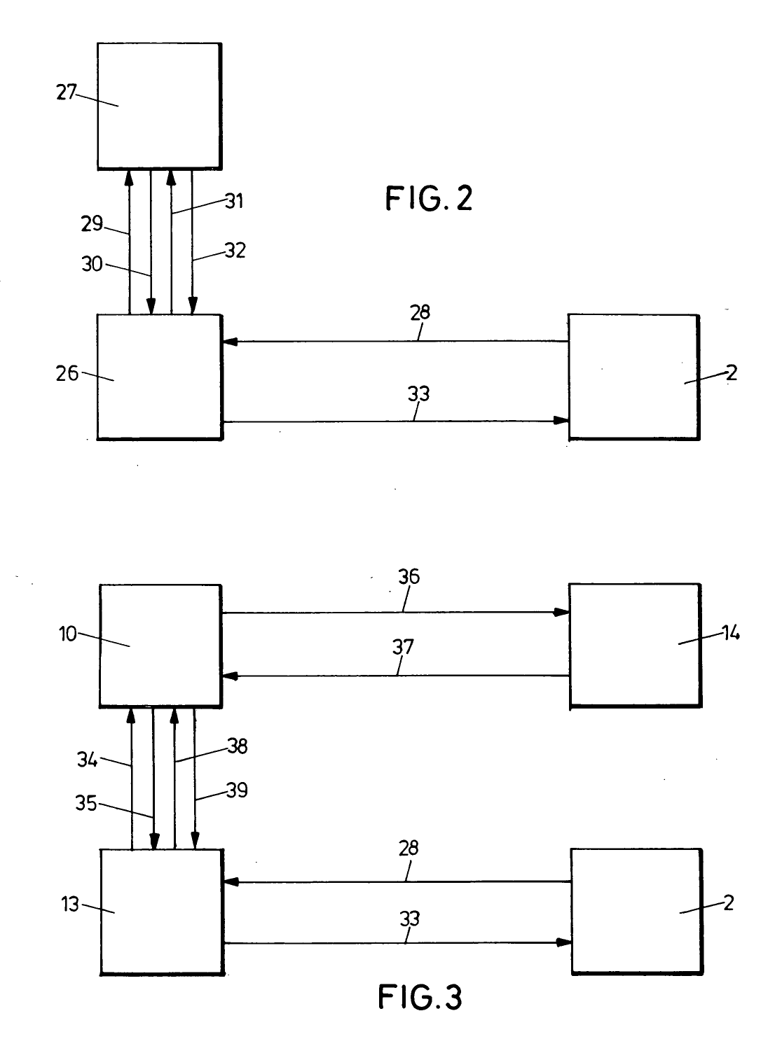

FIG. 2 shows a method for authenticating a mobile telephone according to the prior art; and

FIG. 3 shows an inventive method for authenticating a mobile telephone.

FIG. 1 shows a test system, marked in its entirety with the reference numeral 1, for checking transmission processes in a mobile radio network 2. The test system comprises as the transmission station for data communication purposes a network 3 consisting of transmission units that are in signal connection with one another in a known manner. They may be classified regarding their location as central transmission units 4 and decentralized local transmission units 5, which are separated from one another in FIG. 1 by a schematic separation line 6 in the network 3. FIG. 1 shows that a certain local transmission unit 5 is in connection via a signal path 9, for example an Ethernet connection, and via a simulation computer 10, whose function will be described later, as well as via a signal line 11, with an adapter module 12 of a mobile telephone 13. The communication between the mobile telephone 13 and simulation computer 10 can take place with the aid of a normal bit structure (direct convention) or optionally also with an inverse bit structure (inverse convention). The mobile telephone 13 is in connection in a known manner with the mobile radio network 2 via a wireless signal path 13, i.e., via an air interface.

The mobile telephone 13 is designed in such a way that it is able, with the aid of the Subscriber Identification Module (SIM), to identify itself to the mobile radio network 2 and register for communication in the mobile radio network 2, i.e., in such a way that it permits the performance of a corresponding authentication.

This SIM technology, which is being discussed here representative for data technologies that are used for identifying a mobile telephone to a mobile radio network, is known per se from the market. The data structure of a SIM card is contained in the guideline ETS 300 977 (GSM 11.11) of the European Telecommunications Standards Institute. In the known systems, the mobile telephone is in communication with an actually available, i.e., “physical” SIM card. This physical SIM card is either integrated into the mobile telephone or it is, as is the case in known test systems, connected to the mobile telephone 13 over a remote signal connection.

In the test system 1 according to FIG. 1, a SIM simulation, i.e., a virtual SIM card is being used in lieu of a physical SIM card. For this purpose the mobile telephone 13 incorporates the SIM adapter module 12 and the SIM simulation computer 10. With the aid of these two components, a SIM card simulation is provided in lieu of a physical SIM card by adopting the corresponding data structure. The mobile telephone 13 thus communicates via the adapter module 12, which receives its control information from the simulation computer 10, in an identical manner as this would take place with a physical SIM card. The adapter module 12 is thus connected to the mobile telephone 13 in lieu of a physical SIM card, without any further modifications being required to the mobile telephone 13, compared to the operation with a physical SIM card.

In addition to the above described components the test system 1 also comprises an authentication computer 14, which is in connection via a signal line 15 with a central transmission unit 4 of the network 3. Via signal connections 16, 17, 18, the authentication computer 14 communicates using algorithm modules 19, 20, 21. With the algorithm module 19 it is possible to carry out the authentication algorithm MODULO, which is known per se. With the algorithm module it is possible to carry out the authentication algorithm XOR, which is also known per se. The algorithm module 21 is a physical SIM card, which is connected for communication with the authentication computer 14 to a card reading module 22. The algorithm modules 19 through 21 may be selected as desired.

For purposes of controlling a testing operation of the test system 1, the same incorporates a control computer 23. The latter comprises a central control module 24 and a local control module 25. The control modules 24, 25 are capable of controlling the test system 1 independently from one another. The central control module 24 is connected via a signal line 24a to a central transmission unit 4 of the network 3. The local control module 25 is connected via a signal connection 25a to the local transmission unit 5 of the network 3.

During the operation of the test system, the SIM simulation treats all commands directed from the mobile telephone to the SIM card locally. For this purpose the SIM simulation knows all data ranges defined in GSM 11.11. This includes, for example, the telephone directory stored on the SIM card, as well as the data range for transmitted or received SMS (Short Message Service). After it has been turned on, the mobile telephone first reads this type of information from the SIM card. Since virtually all of these contents are not relevant for the performance of the test, an optimized virtual SIM card is used, which contains, for example, only very few empty entries for the telephone directory or SMS.

The data range is of special importance for the IMSI (International Mobile Subscriber Identity). This IMSI is responsible for the mobile telephone to register for the desired subscriber in the mobile radio network. The value of the IMSI of the SIM card being tested is received by the SIM simulation at the start-up of the control computer 23.

Apart from the IMSI, the SIM simulation does not contain any further personal data from the SIM card. These personal data from the SIM card therefore do not need to be transmitted over the remote signal connection.

The number of communication steps between the mobile telephone and SIM simulation is significantly reduced since, for example, no telephone directory with 100 entries is read out, but only a reduced telephone directory with very few entries. This results in a marked increase in the performance speed.

An additional marked increase in the performance speed results from the fact that the communication steps are performed locally between the mobile telephone and SIM simulation and do not need to be transmitted over the remote signal connection.

The data communication via a data network is considerably slower due to the spatial distance and creation of an appropriate transmission security between the transmitter and receiver, as compared to a direct data communication without interposed data network. The transmission times of a data network communication can be measured by measuring so-called round-trip delay times.

Only the authentication for the subscriber represented by the SIM card cannot be performed locally with the SIM simulation. For this, the authentication computer is needed, which performs, via the interface 18 and card reading module 22, the authentication procedure with the aid of the physical SIM card 21.

For performing the authentication, an authentication process is used that has the objective to reduce the number of communication steps over the remote signal connection. For a fuller understanding of the authentication process, let us first describe below the authentication according to the prior art, with the aid of FIG. 2:

During the authentication according to the arrangement in DE 198 21 529 C1, i.e., according to the prior art, a mobile telephone 26 is in signal connection over a data network that is comparable to the network 3, with a physical SIM card 27 on one hand and with the mobile radio network 2 on the other hand. The authentication according to the prior art then proceeds as follows: First a random number RAND that is generated by the mobile radio network 2 is transmitted in an authentication step 28 from the mobile radio network 2 to the mobile telephone 26. RAND is subsequently transmitted in an authentication step 29 to the physical SIM card 27. The physical SIM card 27 then transmits in an authentication step 30 an acknowledgement signal OK together with an authentication response value SRES (Signal Response)+K_{c} (ciphering key) to the mobile telephone 26. In authentication step 31, the mobile telephone 26 transmits a response request value GET RESULT to the physical SIM card 27. After the receipt of GET RESULT, the physical SIM card 27 transmits, in an authentication step 32, SRES+K_{c} to the mobile telephone 26. The latter then forwards SRES+K_{c} in an authentication step 33 to the network 3. This concludes the authentication according to the prior art. This known authentication according to FIG. 2 can be found, for example, in ISO7816 Part 3.

For the authentication, four communication steps are required according to the prior art over the data network that is comparable to the network 3, namely the authentication steps 29 through 32.

The inventive authentication process will be described below with reference to FIG. 3. There, as already described in connection with FIG. 1, the simulation computer 10 and the authentication computer 14 are connected to one another over a data network, namely the network 3.

The authentication step 28 corresponds to the one in FIG. 2. In an authentication step 34, the mobile telephone 13 transmits RAND to the simulation computer 10. In an authentication step 36, the simulation computer 10 transmits RAND to the authentication computer 14. In the authentication computer 14, SRES+K_{c} is subsequently calculated with the aid of one of the algorithm modules 19 through 21. SRES+K_{c} is then transmitted in an authentication step 37 to the simulation computer 10. Afterwards the simulation computer 10 transmits to the mobile telephone 13 in an authentication step 35 an acknowledgement signal OK, which acknowledges the successful calculation of the authentication response value SRES+K_{c} and at the same time reports the response length of the calculated authentication response value SRES+K_{c}. In an authentication step 38, the simulation computer 10 receives from the mobile telephone 13 the response request value GET RESULT. The authentication steps 36 and 37 together with the calculation of SRES+K_{c} in the authentication computer 14 may take place in parallel with the authentication steps 35 and 38. After the authentication step 38, the simulation computer 10 transmits, in an authentication step 39, SRES+K_{C} to the mobile telephone 13. The subsequent authentication step 33 corresponds to that of FIG. 2.

In the inventive authentication process, two communication steps over the remote signal connection are required. In this manner the authentication can be performed in a timely manner even in the case of very long delay times during the transmission over the remote signal connection.

The testing of transmission processes in the mobile radio network 2 takes place as follows: First the mobile telephone 13 is taken to a location where the test is to take place. The simulation computer 10, which is equipped with the desired SIM data, is then connected at this location to the mobile telephone 13. The test is then started, controlled by the control computer 23, i.e., either locally from the mobile telephone 13 via the local control module 25, or centrally via the central control module 24. The authentication of the mobile telephone 13 for this takes place as explained above in connection with FIG. 3. By means of an appropriate selection of a SIM simulation, which is provided by the simulation computer 10, different types of access to the mobile radio network 2, for example roaming, can be tested. Additionally it is possible to test selected operating modes, for example “two users with identical SIM data” or different mobile radio networks 2. Of course, the SIM simulation of the simulation computer 10 does not necessarily need to have a physical counterpart in the form of a physical SIM card. It is therefore possible to field-test with the test system 1 future SIM technologies. The simulation computer 10 may also be implemented in such a way that SIM data is stored on it for a plurality of SIM cards.

Based on the given selected SIM simulation or due to a corresponding setting by the control computer 23, the authentication computer 14 selects during the authentication process an algorithm module 19 through 21. The communication with the algorithm module 21, i.e., with the physical SIM card, turns out significantly accelerated during the inventive authentication as compared to that of the prior art, since it is not necessary to proceed according to the authentication standard according to ISO with the described four communication steps over the remote signal connection. It suffices, within the framework of two communication steps, to first supply RAND from the authentication computer 14 to the algorithm module 21 (communication step 1) and then to transmit the SRES+K_{c} calculated by the algorithm module 21 back to the authentication computer 14 (communication step 2).

In addition to the mobile telephone 13 shown in FIG. 1, additional mobile telephones may also be connected at the same time to the simulation computer 10 for testing. It is also possible, within the framework of testing multiple mobile telephones 13, to use a plurality of authentication computers 14. A plurality of simulation computers 10 may be provided in the test system 12 as well. The simulation computer 10 and/or the authentication computer 14 may, of course, also be implemented in such a way that they can communicate with multiple mobile telephones 13 at once.

The simulation computer 10 and the local control module 25 may also be integrated in one computer.

The described test serves in particular to test the wireless signal connection 13a between the mobile telephone 13 and mobile radio network 2.

1. A test system (1) for checking transmission processes in a mobile radio network (2),
incorporating at least one local mobile telephone (13) that is implemented in such a way that it can communicate with a Subscriber Identification Module (SIM),
incorporating at least one transmission unit (3) comprising at least one local transmission unit (5) assigned to the mobile telephone (13) and connectable to the same,
incorporating a local SIM simulation computer (10) for providing a SIM simulation, in which SIM data are stored and which is connected to the local transmission unit (5) on one hand and via an adapter module (12) to the mobile telephone (13) on the other hand,
incorporating a control computer (23) for controlling a testing operation, which is connected to the mobile radio network (3), and
incorporating at least one authentication computer (14) for carrying out an authentication algorithm for authenticating the mobile telephone (13), said authentication computer being connected to the SIM simulation computer (10), wherein the simulation computer (10) is implemented in such a way
that in the simulation computer (10), SIM data are being stored for a plurality of SIM cards,
that it can be connected to a plurality of mobile telephones (13).

2. A test system according to claim 1, characterized in that the authentication computer (14) is connected via the transmission unit (3) to the simulation computer (10).

3. A test system according to claim 1, characterized in that the simulation computer (10) is implemented in such a way that it can simulate SIM cards that are not physically available.

4. A test system according to claim 1, characterized in that the simulation computer (10) is implemented in such a way that it can be connected to a plurality of authentication computers (4).

5. A test system according to claim 1, characterized in that the authentication computer (14) is implemented in such a way that it can be connected to a plurality of simulation computers (10).

6. A test system according to claim 1, characterized in that the authentication computer (14) is implemented in such a way that it can carry out a plurality of authentication algorithms (19 through 21).

7. A test system according to claim 1, characterized in that the authentication computer (14) is implemented in such a way that it can be connected for the calculation of an authentication response value to a physical SIM card (21).

8. A method for authenticating a mobile telephone (13) in a mobile radio network (2) using a test system (1) according to claim 1, comprising the following steps:
generation of a random number RAND by the mobile radio network (2),
transmission (28) of RAND from the mobile radio network (2) to the mobile telephone (13),
transmission (34) of RAND from the mobile telephone (13) to the simulation computer (10),
transmission (36) of RAND from the simulation computer (10) to the authentication computer (14),
calculation, in the authentication computer (14), of an authentication response value SRES+K_{c} from the RAND and at least one additional characteristic value that is individually assigned to the SIM simulation,
transmission (37) of SRES+K_{c} from the authentication computer (14) to the simulation computer (10),
transmission (35) of an acknowledgement signal OK, which acknowledges the successful calculation of the authentication response value SRES+K_{c} and at the same time reports the response length of the calculated authentication response value SRES+K_{c}, from the simulation computer (10) to the mobile telephone (13),
transmission (38) of a response request value GET RESULT from the mobile telephone (13) to the simulation computer (10),
transmission (39) of SRES+K_{c} from the simulation computer (10) to the mobile telephone (13),
transmission (33) of SRES+K_{c} from the mobile telephone (13) to the mobile radio network (2).
